(19) United States
(12) Patent Application Publication
(10) Pub. No.: US 2006/0015299 A1
(43) Pub. Date: Jan. 19, 2006

(54) Network architecture and protocol for spacecraft systems

(76) Inventors: Scott A. McDermott, Washington, DC (US); Luis G. Jordan, Charles Town, WV (US); Thomas Vaneck, Gloucester, MA (US); Simon Morris Shand Weiss, Boston, MA (US)

Correspondence Address: ROBERT M. MCDERMOTT, ESQ., 1824 FEDERAL FARM ROAD, MONTROSS, VA, 22520, US

(21) Appl. No.: 11/151,909

(22) Filed: Jun. 14, 2005

Related U.S. Application Data
(60) Provisional application No. 60/579,231, filed on Jun. 14, 2004.

(51) Int. Cl. G21C 17/00

(52) U.S. Cl. 702/188; 702/184

(57) ABSTRACT

A network architecture and protocol provides “plug and play” spacecraft capabilities. A distributed-control architecture is used, wherein each component operates semi-autonomously, and interacts with other components on a task/resource level. Each component announces its requirement for system resources as a request to the network, and components that can provide some or all of the requested resources respond to the request. An arbitration device centralizes and coordinates requests for critical and/or singular resources, such as requests for a specific orientation of the spacecraft. To facilitate such distributed control, requests are made in advance of the requirement for the resource, and include a time interval during which the resource is required. A configuration and test system is provided to process the mission requirements and provide a set of components that can be configured to satisfy the requirements.

This application claims the benefit of U.S. Provisional Patent Application 60/579,231, filed 14 Jun. 2004.

### BACKGROUND AND SUMMARY OF THE INVENTION

This invention relates to the field of spacecraft systems, and in particular to a network architecture and protocol for spacecraft systems.

Spacecraft systems include a variety of functional components, and the interaction among these components requires substantial coordination. In a conventional spacecraft system, a control component is responsible for managing this coordination and interaction. Thus, each different spacecraft typically requires a different, custom-designed, control component.

Although most designers strive to design functional components that can be reused in different spacecraft, the use of custom-designed controllers often negate such reuse, typically because the interface required by the custom-designed controller does not correspond to the interface provided by the functional component that was designed before the design of the controller, or was designed independently of the controller. If the component is designed independently of the controller, such as a component designed after the controller, it may include functions or capabilities that are unknown to the controller, and will go unused, or will require a redesign of the controller to take advantage of these functions and capabilities. Similarly, each different alternative to a similar-function component may not be designed to provide the same interface as the other alternatives. For example, the interface to a propulsion thruster is typically significantly different than the interface to an inertial stabilizer, even though both units can be used to perform a “change orientation” task. Similarly, the interface to a two-port memory component differs from the interface to a one-port memory component, even though either device can be used to perform a “store” or “recall” task.

In like manner, different functional components may use different reference systems for similar parameters. For example, some components may communicate coordinates or orientations based on a solar-referenced coordinate system, and others may communicate such coordinates or orientations based on a spacecraft-referenced coordinate system. Similarly, some parameters of a component, such as its relative location in the spacecraft, or its available capabilities need to be provided to the designer of the spacecraft in order for the spacecraft designer to properly integrate the component into the overall structure of the spacecraft.

Even when functional components are designed to be reused, and a controller is designed to use the interface provided by these components, the design of the controller is substantially affected by the particular mission profile. The designer of the controller must be aware of the requirements for each component throughout the mission. Alternatively, ground control personnel must be aware of these requirements as the mission progresses, and must program the controller accordingly. In either event, the coordination of the functional components remains a complex task. For example, the controller must be programmed to point the spacecraft to particular positions at different times, but the pointing of the spacecraft to satisfy the requirements of one component may interfere with the proper operation of another component. In like manner, the external components of a spacecraft, such as antennas and solar panels, may require deployment to a particular orientation at a particular time, or under particular circumstances, but such orientations may interfere with the operation of functional components such as cameras and other sensors that have limited fields of view.

Other aspects of spacecraft operation also require coordination among the components. For example, many functional components or functional tasks have varying power requirements, such as a data collection component that uses minimal power to collect the data, and substantially greater power to process or transmit the data. Without proper coordination, the spacecraft would need to be configured to handle a worst-case condition of all such components consuming maximum power at the same time, or all tasks requiring the communication of data at the same time. Conventionally, the spacecraft controller must be programmed so as to distribute the power and communication requirements of the various components over time, to avoid such worst-case conditions, and therefore establish lesser requirements for the power and/or communication resources.

Conventional spacecraft design also typically requires that the physical arrangement of functional components be known a priori, so that, for example, attitude-control components can be properly controlled, based on their relative position in the spacecraft, and based on the distribution of mass in the spacecraft.

It is an object of this invention to optimize the potential for providing reusable functional components for spacecraft. It is a further object of this invention to reduce the need for custom-designed spacecraft controllers. It is a further object of this invention to allow functional components to use and/or provide all of their capabilities, without regard to whether a master-controller is aware of these capabilities. It is a further object of this invention to reduce the likelihood of spacecraft commands that unintentionally adversely affect the operation of functional components. It is a further object of this invention to distribute resources over time, so that peak demands can be minimized. It is a further object of this invention to increase vehicle reliability by providing an automatic graceful failover from one functional component, to another functional component capable of providing similar capabilities in a different way.

These objects, and others, are achieved by a network architecture and protocol that provides “plug and play” spacecraft capabilities. A distributed-control architecture is used, wherein each component operates semi-autonomously, and interacts with other components on a task/resource level. Each component announces its requirement for system resources as a request to the network, and components that can provide some or all of the requested resources respond to the request. An arbitration device centralizes and coordinates requests for critical and/or singular resources, such as requests for a specific orientation of the spacecraft. To facilitate such distributed control, requests are made in advance of the requirement for the resource, and include a time interval during which the resource is required. A configuration and test system is provided to process the mission requirements and provide a set of components that can be configured to satisfy the requirements.

### BRIEF DESCRIPTION OF THE DRAWINGS

The invention is explained in further detail, and by way of example, with reference to the accompanying drawings wherein:

FIG. 1 illustrates an example set of spacecraft components interconnected via a network in accordance with this invention.

FIGS. 2A-2D illustrate example flow-diagrams of transactions among spacecraft components in accordance with this invention.

FIGS. 3-4 illustrate example transactions among spacecraft components in accordance with this invention.

FIG. 5 illustrates an example resistor network that facilitates component location-determination in accordance with this invention.

FIG. 6 illustrates an example block diagram of an over-current protection system in accordance with this invention.

FIG. 7 illustrates an example block diagram of a switching system that facilitates on-demand wire allocation in accordance with this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The preferred network and protocol for a spacecraft system is modeled after the conventional “plug and play” concept developed for personal computers. Ideally, a required and/or desired component is “plugged into” the spacecraft system, and the capabilities of the component are made available to the system. As contrast to a personal computer system, however, most spacecraft components are not “stand-alone” components, and require resources and/or services from other components. Also as contrast to a personal computer system, the structurally integrated and mobile nature of a space vehicle requires the sharing of additional information among components, such as mass, position, and dynamic properties.

For ease of reference, the term “service” is used hereinafter to identify the satisfaction of a request of one component by another component; such service may merely include providing access to a required resource, such as power, or may include performing a complex process, such as re-orienting the spacecraft, to satisfy the request. For example, a video-capture component will typically require the services of an attitude-control component to orient the spacecraft in the proper direction, the services of a power supply component to provide power, and the services of a communication component to transmit the captured images to a ground station. Thus, for a component to “plug and play” in a spacecraft system, capabilities must be provided for coordinating the cooperative operation among multiple components, including not only functional but mechanical characteristics.

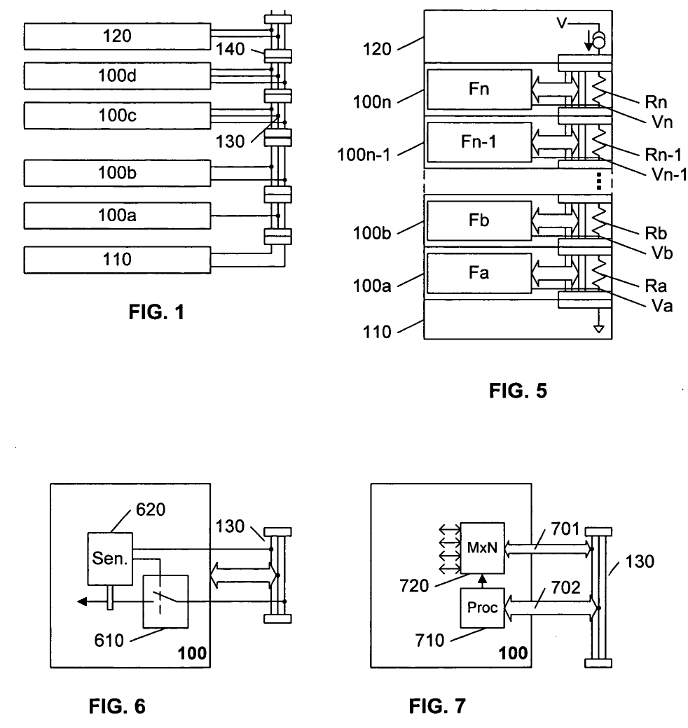

FIG. 1 illustrates a typical spacecraft comprising components 100a-d, 110, and 120, interconnected via a network 130. Such components include, for example, a power-supply component, a processing component, a communications component, an attitude-control component, and so on. Each of the illustrated components 100a-d, 110, and 120 may represent multiple components, the number and type of each component being dependent upon the particular spacecraft configuration.

FIG. 1 illustrates the network 130 as a “daisy-chain” of components, wherein each component plugs into plugs/sockets 140 on each adjacent component; however, other network configurations, such as “ring”, “star”, or “ad-hoc” networks, or a combination of a variety of configurations may also be used. In like manner, although the network 130 may imply a “wired” connection among the components, the network may include wireless connections among the components, such as RF and IR communication channels. FIG. 1 also illustrates “pass-through” connections of all of the signals on the network 130 from one component to the next, although as will be evident in the following details of the invention, some or all of the components may include components in series with the connection between its adjacent components. In like manner, if the network 130 includes, for example, fiber-optic communications, the network 130 may include transducers/couplers that extract information from the network 130 in one form and convert it to another form for transfer to the components.

A distinction is made in FIG. 1 between components 100a-d, collectively referred to as components 100, and components 110, 120, because it is recognized that in some spacecraft configurations, one or more (110, 120) of the components may be special-purpose, and may not necessarily conform to the network requirements of the ‘standard’ components 100. Generally, these special-purpose components 110, 120 include such components as a payload component, an antenna component, a solar-array component, a launch-vehicle-coupling component, and so on. In the context of this disclosure, such components 110, 120 may include components that comprise terminating elements to the network signals, such as components that provide reference voltages that the other components 100 rely upon, impedance-matching elements that minimize reflections on the signal lines, and so on. Hereinafter, constraints that are explicitly or implicitly placed on the components by the network architecture and protocol described herein refer to constraints on components 100, and only optionally/selectively apply to the components 110, 120. The components 110, 120 may be considered to include one or more components 100 that conform to the constraints and protocol defined herein, as well as additional elements that may not conform.

As noted above, conventionally, a “spacecraft controller” provides the coordination among multiple components, by directing the operation of each component. Such a centralized control, however, requires that the controller, or more specifically, the designer of the controller, must be aware of all of the cross-component interactions, and correspondingly manage each component to provide the required cooperative operations. Centralized control also implies a central point of failure, which is conventionally dealt with by mass-inefficient and complexity-increasing means such as “cold sparing” or “backdoor” radio commands.

In a preferred embodiment of this invention, the components 100 are configured to request services from other components 100, and, conversely, to respond to such requests from other components to provide requested services to the other components. For example, an attitude-control component requests power to effect changes in orientation, a power-supply component requests changes in orientation to capture solar energy, a communication component requests both power and changes in orientation to communicate with ground-stations, a video-capture component requests power, orientation, and communication services, and so on. The power-supply component responds to the requests that it is able to satisfy, as does the communication component and the attitude-control component.

Ideally, all of the components 100 are able to satisfy all of the requests for services upon demand. In reality, some coordination among the multiple requests is typically required. In accordance with the principles of this invention, a variety of techniques are provided to facilitate this coordination without requiring the imposition of mission-specific design elements, or the inclusion of a traditional “master-controller”.

One such technique to facilitate the coordination of multiple requests is to distribute the satisfaction of the requests over time. To effectively employ this technique, the components 100 are preferably configured to submit their requests in advance of the need for the service. For example, all components 100 typically require power to operate, but also may require substantially higher power to “power-up” to begin operations. If the power-supply component attempts to provide power to all of the components that request power as soon as it is able to provide power, it is likely that the demand will exceed the capability of the power-supply component, and problems will develop. However, if the power-supply component is provided advance notice of demands for its services, the satisfaction of the demands can be distributed over time. This eliminates the need for complicated a priori mission planning that requires human operators to take into account the various power and other resource needs of the spacecraft subsystems.

In a straightforward embodiment of this aspect of the invention, a component 100 requests a service in advance, specifying when it needs the service; if a providing component can provide the service at that time, it responds favorably. If the requesting component 100 is denied the service at the requested time, it can request the service at different times until the request can be satisfied, and modifies its schedule of operations accordingly. In this manner, by requesting and scheduling services in advance, the components provide the required coordination among activities, without requiring mission-specific software or operation design.

In a preferred embodiment, each component 100 associates a required time-frame in its request for service, in either absolute or relative terms. The relative terms can be specified with regard to spacecraft events, such as “launch”, “in orbit”, “sunrise”, “sunset”, and so on. The time-frame can include a variety of forms, such as “continuously”, or “immediately upon achieving orbit”, or “soon after achieving orbit”, or “during daylight after achieving orbit”, or “for at least twenty minutes during every orbit” and so on. In this way, the providing component can allocate its available resources effectively to satisfy these requirements. That is, in a preferred embodiment, each request includes a time-parameter that identifies when the service is desired, and the determination of when to provide each requested service rests with the provider of the service, rather than with a master-controller that attempts to make such determinations for all of the components. Such a system architecture generally requires that each component includes some resource-management processing capabilities, but by providing these capabilities in each component, the need to custom-design a master-controller to manage the allocation of resources/services provided by each component for each spacecraft mission is virtually eliminated.

As is common in most resource-allocation schemes, priorities are associated with each request for service, to facilitate a determination of which requests to fulfill and which to reject in the event of conflicting requests. In a spacecraft system, the priority of a request for service is typically based on the implications of that service being unavailable. That is, if the unavailability (either present or the sudden future removal) of a requested service would cause serious spacecraft operational difficulty, that request would be at a high priority. If the sudden removal of a requested service would cause an inconvenience to mission operations, then it would be at a low priority, such that a high-priority request could cause that inconvenience in the interest of securing fundamental spacecraft health. In a conflict between two requests of like priority, preference is given to the request that has already been granted, in recognition that removing a promised service is typically more distressing than not promising the service in the first place.

Another technique to facilitate the coordination of multiple requests is to provide an “arbitration” system that is configured to resolve conflicts when there are multiple potential providers of the same service and they cannot be allowed to interfere with each other. This occurs, for example, when there is both a reaction-wheel system and a propulsion system on the spacecraft, and they cannot be allowed to independently offer spacecraft pointing services to different requesters. Techniques for arbitration techniques beyond a simple priority ranking scheme are common in the art, and include, for example, expert-system technologies including knowledge-based rules systems, machine-learning systems, and so on. Note that, as contrast to a master-controller in a conventional spacecraft, the arbitration system does not control the operations of the components, per se; rather, it facilitates the resolution of this class of resource conflict where independent providers cannot act independently. If conflicts do not arise, the arbitration system has no effect on the operation of the spacecraft components 100. Because the arbitration system is generally embodied as a software process, it can be located in any component 100 that has sufficient processing and memory capabilities to effectively host the arbitration task.

It is significant to note that sparing and redundancy may be accomplished simply by having multiple copies of the arbitration software on the various components 100, with only one of these copies active at a time. Additionally, the arbitration software may be ‘partitioned’, wherein special-purpose arbiters are provided to address the arbitration of specific services. For example, a ‘power’ arbiter may be included with all power-providing modules, a ‘pointing’ arbiter may be included with all spacecraft-pointing modules, and so on. In this manner, the inclusion of any of the likely conflict-producing modules in a spacecraft will be known to include an arbiter for resolving the conflict; as above, only one of the special-purpose arbiters for the contested service is enabled at any time.

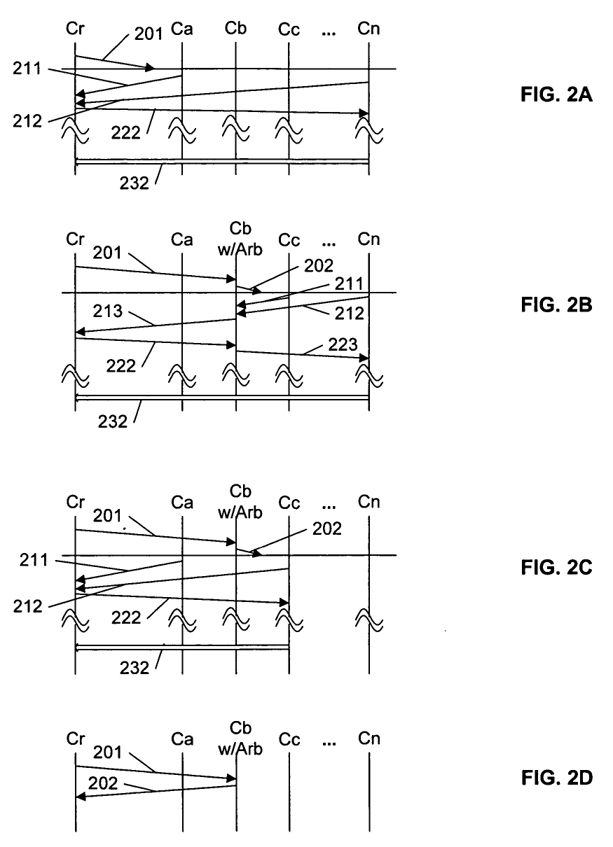

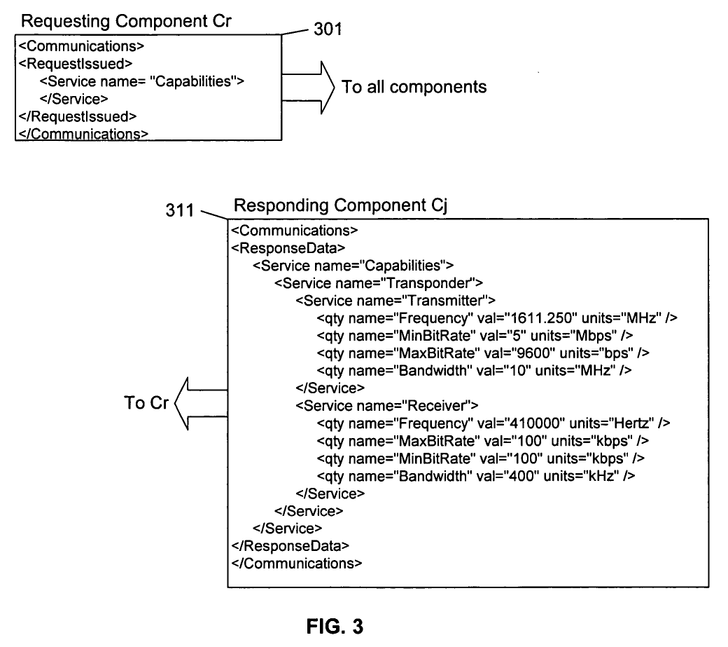

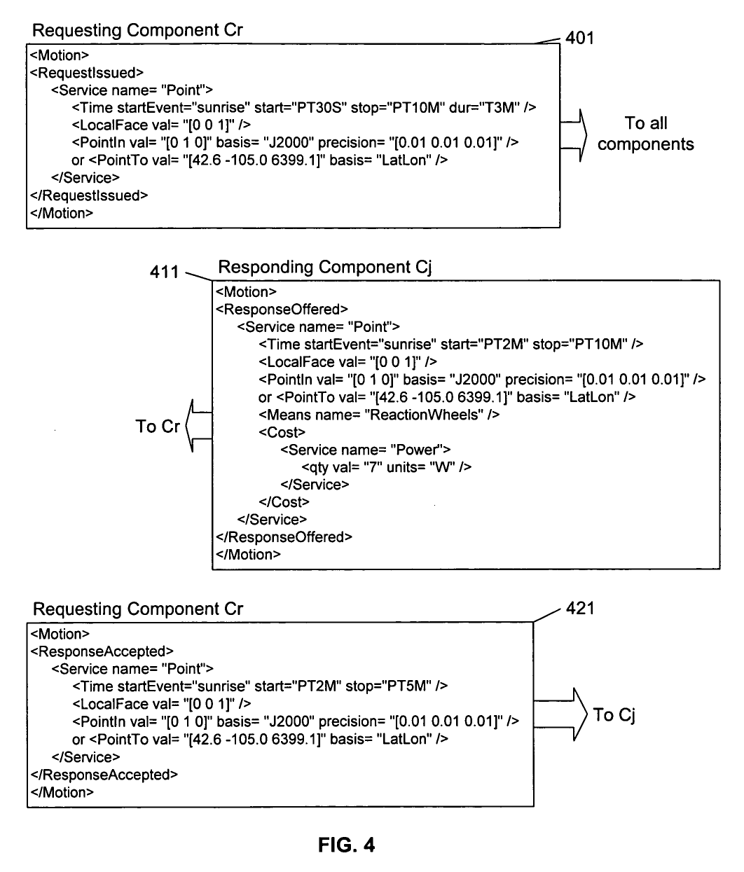

FIGS. 2A-2D illustrate example flow-diagrams of request and response transactions. As noted above, the examples in these figures, and correspondingly FIGS. 3-4, are provided as illustrative examples; one of ordinary skill in the art will recognize that other protocols and schemas may be used to effect the request-response architecture detailed herein.

In FIG. 2A, a requesting component Cr communicates a request for service 201. As illustrated by the horizontal line segment, this request 201 is communicated to all other components Ca-Cn, and to the arbiter system A. In this example, component Ca and component Cn can satisfy the request, and they provide an affirmative response 211, 212, respectively, to the requesting component Cr. In a preferred embodiment of this invention, the affirmative responses 211, 212 may include refinements to the request 201, such as a refinement of the time interval that the service will be available, or a constraint to a parameter associated with the service that was not specified, or loosely specified in the request, and so on. Additionally, the responses 211, 212 may include one or more “cost” parameters associated with satisfaction of the request. For example, the cost may be associated with the amount of resources (fuel, stored energy, etc.) expected to be consumed by the component to satisfy the request, or with the amount of inconvenience to other components (e.g. rescission of lower-priority commitments, obstruction of viewing angles, etc.) expected to be caused by satisfying the request, and so on. These cost parameters may be dynamic, and include, for example, time or event dependencies. For example, the cost of providing electrical power may be substantially higher during the sunset-to-sunrise period of each orbit, or the cost of propellant may be inversely proportional to the amount of propellant remaining, and so on.

The requesting component Cr selects between these providers of the requested service, preferably based on the costs associated with each response, as well as any refinements to the request in each response, and communicates a service-accepted message 222 to the selected component Cn. Optionally, the component Cr may also be configured to communicate a service-declined message to the non-selected component Ca, to release the component Ca's commitment to provide this service; alternatively, each component can be configured to release itself from a commitment if the service is not accepted within a given time span, or whenever it monitors a service-accepted message for the request that is address to another component. At the scheduled time of the requested service, the providing component Cn provides the requested service 232 to the requesting component Cr.

FIG. 2B illustrates an example transaction where the request 201 is of the class that cannot be independently offered by a variety of components Ca-Cn, and must be sent to a singular component for arbitration. In this example, component Cb contains the arbitration function. Component Cb determines there is no inter-component conflict in the request, repeats the request 201 to components Ca-Cn as request 202, and receives their parallel offers. Component Cb passes one, several, or all of these offers back to the requester Cr. The requester Cr chooses an offer in the same fashion as FIG. 2A, and communicates a service-accepted message 222 to the arbitration component Cb. The arbitration component Cb then relays the service-accepted message 223 to the selected offeror Cn, and optionally sends a service-declined message to offerer Ca. An arbitration function behaving in this manner is simply acting as any other service provider that requires other services from other service providers in order to satisfy the request.

FIG. 2C shows the same request 201 which requires arbitration, but in this case, the request 202 which is forwarded to components Ca-Cn contains the information that the actual requester is component Cr. Once the request 202 is issued, the flow of FIG. 2C proceeds as FIG. 2A, with the offerors interacting directly with the requester Cr. In this example, the requesting component Cr accepts 222 the offered service 212 from component Cc, and component Cc provides the service 232 at the scheduled time to component Cr. An arbitration function behaving in this manner is acting as a gateway, either allowing or disallowing the request 201 to be broadcast to all components as request 202. This is more efficient in a messaging sense but can make it more difficult for the arbitration function to keep track of the service commitments made for a given singular service (independent of offeror) at a given time.

FIG. 2D shows the same request 201 which requires arbitration, but where the service being requested is already being provided to another requester at the same or higher priority. Since singular services (which cannot be provided to multiple requesters simultaneously) are routed through an arbitration function, this request must be denied, even if there may be some component that believes it could provide the service. The arbitration unit thus sends a request-denied message 214 to requester Cr.

In a preferred embodiment, the requests for services are addressed by “service type”, and each component that can provide a service within the given service type evaluates the request to determine whether it can satisfy the request. An example set of service types follows:
Communications—space-ground links and space-space links.
Motion—spacecraft pointing (orientation) and propulsion (orbital parameters).
Position knowledge—attitude (orientation) and orbit location (absolute and relative).
Power—electrical power supply.
Arbitration—conflict resolution and overall spacecraft monitoring.
Memory—data storage.
Processing—non-real-time data processing.
Imagery—on-board cameras and other visual/scanning devices.
Payload—mission-unique components.
Time—spacecraft timekeeper and source of synchronization pulses.
Ground Operations—ground testing or operations equipment.
Other—services that are not included in any of the above.
   Additionally, a service type of “All” is provided, to which requests all components are expected to listen.

The messages are distinguished by a message-type, which includes:
RequestIssued—the aforementioned request for services.
ResponseOffered—the response to a request, offering satisfaction of the request.
ResponseAccepted—the acceptance of an offer by the requesting component.
ResponseData—additional data/details related to an accepted or offered response.
RequestWithdrawn—the withdrawal and/or non-acceptance of an offer.
ResponseWithdrawn—the rescission of a prior accepted response, or a reduction of the service provided.

The request for services is not limited to “active” services, and may include, for example a request for information, or a request that some action be initiated by another component. The request for services may include, for example, a request for “capabilities”, wherein a component announces its capabilities to the requesting component, and, by default, to the network. With such a request, the reply may include the requisite response-offered, response-accepted communication, or it may merely be a response-data reply, wherein the component(s) that can provide services of the particular service-type respond with an itemization of their capabilities for services in that service-type. In like manner, a component may request a request from another component, wherein, for example, a component receives a request from a first component, but is expecting a request from a second component. Before responding affirmatively to the request of the first component, the component may prompt the second component to submit the expected request, via such a request for a request. Or, select components may be configured to issue such requests for requests to higher priority components whenever it receives a request from a relatively low priority component, to avoid the need to subsequently rescind the promise to provide the service at some later point in time.

One of the commonly used request for services includes a “physical parameters” query, wherein the responding device reports its physical parameters, such as its mass, center of gravity, physical extents, location and orientation relative to the spacecraft's coordinate system, and so on. Using such parameters, other components, such as momentum-wheel components and other attitude-adjusting components can modify their operations accordingly. Optionally, these parameters may be partitioned into different categories, using, for example a distinction between “physical” parameters such as size, shape, and location, of which many components, particularly viewing components, may have an interest, “mechanical” parameters, such as mass and center-of-inertia, which other components, particularly spacecraft motion components, may have an interest, “network” parameters, a list of which service-types the component listens for, and so on.

Similarly, the request for service may include a request for an identification of a component's electrical characteristics, such as a component's ability to provide electrical power. Generally, the response to this request includes a component's ability to provide power during each phase of the spacecraft's orbit, and is provided as either a response-offered message, or as a response-data message.

Other requests for service may include, for example, an “Are you there?” request (wherein the responding unit merely echoes the request), a “Telemetry” request (wherein the responding unit provides its current operating conditions, such as current power consumption, ambient temperature, and so on), an “Address” request (wherein the responding unit provides its access information, such as its current IP address, it current IP status, and so on), and others.

Each of the different requests for services are identified by a service-name, such as “PhysicalParameters”, “Capabilities”, “Telemetry”, “ElectricPower”, “Point”, “Transmitter”, “Receiver” and so on. In response to a request for “Capabilities”, each component provides a listing of all of the services that it can provide, by service-name. Additionally, or in response to a request for capabilities within a service-name, each component provides a list of parameters associated with each service-name.

FIGS. 3-4 illustrate example request-response transactions.

FIG. 3 illustrates an example request-for-communications-capabilities transaction. The request for service 301 from a requesting component Cr identifies the service-type as “Communications”, and in so doing, allows components that do not provide communication services to ignore the remainder of the message. As is common in most network protocols, a message “header” (not illustrated) contains information regarding the intended recipients, as well as the sending component, or the reply-to component. In this example, consistent with FIG. 2A, the intended recipients of the request (201 in FIG. 2A) are all of the components. That is, the message is sent to all components, but, based on the service-type, only those components that provide communication services need process the message beyond the service-type (“Communications”) field. The message-type is “RequestIssued”, and the name of the requested service is “Capabilities”. The preferred protocol/format allows for variable-length fields and records, for examples, as expressed by the eXtended Markup Language (XML).

In response to the request for service 301, a responding component Cj provides a response 311. The response identifies the service-type “Communications”, and the message-type is “ResponseData”. The responder identifies the message as being in response to the requested “Capabilities” service, and then proceeds to list each of its available services, and optionally, parameters associated with each service. In this example, the responder reports that it has “Transponder” services available, including “Transmitter” service and “Receiver” service. Parameters associated with the transmitter service include a frequency of 1611.250 MHz, a bit rate between 5 and 9600 Mbps, and a bandwidth of 10 MHz. In like manner, the receiver service includes a frequency of 410000 Hz, a bit rate of 100 kbps, and a bandwidth of 400 kHz.

The other components that can provide communication services will each reply similarly. Having been informed of the available communication services, the requesting component Cr, or any other component that monitored the capabilities responses, can subsequently conform their behavior to use such services as required.

FIG. 4 illustrates an example request-response transaction for orienting/pointing the spacecraft. The requesting component identifies the service-type as “Motion” and directs the request to all motion-capable components. As noted above, the service type of “Motion” is in the class of services which must be routed through the arbitration system; thus, the requester Cr in this exchange is presumably the arbiter. However, a requirement that motion requests originate from an arbiter is not necessarily an imposed constraint, in order to allow uncommon requests from motion from sources such as ground operators, “mother ships” in a formation flying satellite cluster, and so on.

Note that if multiple devices had previously identified themselves as being able to provide motion services during a request-for-capabilities transaction, the requesting component may specifically address the request for pointing to a particular component whose available services match the requirements of the request, to minimize overhead.

The message-type is a “RequestIssued”, the requesting component is “Cr”, and the service-name is “Point”. The “Time” parameter associated with the request indicates that the service is requested relative to “sunrise” event, and the time span starts at sunrise plus 30 seconds (“PT30S”), and extends until sunrise plus 10 minutes (“PT10M”). Within that time span, the service is required for a duration of three minutes (“dur=“T3M””).

The direction to “point” the spacecraft can be specified in a variety of forms. Although absolute coordinates can be used, in a preferred embodiment, directions and locations can also be specified relative a spacecraft-based coordinate system, and/or a spacecraft-surface coordinate system. For example, a component may identify a plane in which its camera lens is located, and request that the identified plane be pointed normal to the specified direction. Such a plane can be specified with regard to a defined origin and orientation of a spacecraft-based coordinate system, to avoid the need for each component to determine a star-based, or earth-based, or other relatively-absolute direction vector.

In a preferred embodiment, because a spacecraft typically has a regular structure, with relatively few planes/surfaces upon which components are mounted, the use of a spacecraft-surface coordinate system, such as numerical indexes to the finite number of surfaces, or walls, of the spacecraft, can further substantially simplify each component's need to identify the reference plane for its devices. For example, the direction parameter can merely state “point surface 3 normal-to the following direction”. For a device that has multiple viewing devices, on every other surface, the direction parameter can state “point any of surfaces 1, 3, or 5 in this direction”. Additionally, the required direction may be relative, such as “point to the center of the sun”, or “point to Washington, D.C.”, and so on, thereby again relieving the requesting component the need to determine coordinates and/or to perform dynamic coordinate transformations. In a preferred embodiment, the component that is capable of pointing the spacecraft includes the resources required to respond to requests such as “point surface 3 normal to Washington, D.C.”, or these components include the requisite capability to request the appropriate services from other components to effect a solution to such a request. In this manner, all pointing-requiring components need not include such a capability.

In response to the request 401, a responding component provides a response 411 to the requesting component Cr. The response indicates a service-type of “Motion”, message-type of “ResponseOffered”, and a service-name of “Point”.

In this example, the responding component Cj refines the “Time” parameter to indicate that the requested pointing can be provided between sunrise (startEvent=“sunrise”) plus 2 minutes (“PT2M”) and sunrise plus 10 minutes (“PT10M”). That is, although the request specified a time-span of “30 seconds to 10 minutes after sunrise”, the responding component is advising the requester that a time span of “2 to 10 minutes after sunrise” is the only available time that this component can provide the requested service. The other pointing parameters are the same as in the request, and additional parameters relative to the response are provided. The response indicates that the means for providing the pointing service is via “Reaction Wheels”, and also indicates the expected costs, in terms of consumed power, to satisfy the request. The cost parameters facilitate component Cr's selection among alternative responses, as does the identification of the means for providing the service. For example, knowing that reaction wheels will be used to effect the positioning, the requesting component's feedback-loop elements may be modified to anticipate a particular pointing-reaction time, or some other effect known to be associated with reaction-wheel orientation devices. Or, in some cases, the response may be declined by the requester Cr because of the anticipated secondary-effects of the means provided by responder Cj.

The requesting component Cr accepts the response from the offering component Cj via a response 421 addressed to component Cj. The response 421 indicates a service-type of “Motion”, accepting the offer to component Cr for a point service. In this response 421, the requesting/accepting component Cr further refines the “Time” parameter, indicating that it accepts the requested pointing starting at sunrise plus two minutes and ending at sunrise plus five minutes. Because a duration is not specified, it is assumed that the service will be required for the entire duration between 2-5 minutes after sunrise. Alternatively, the accepting component Cr could have left the specific time within the offered time-span of 2-10 minutes after sunrise ‘open’, and merely reiterated its need for a three minute duration anytime within the offered time-span.

One of ordinary skill in the art will recognize that the example message format in FIGS. 3-4 is presented for illustrative purposes, and is only one of many formats that may be used. For example, each issued request could contain a request-identifier, and all subsequent communications related to this request could contain a reference to this identifier. In this manner, each communication need not repeat the information contained in the initial request, and need only identify refinements or other changes to the request. Similarly, different communication channels, or ports, could be used for each different service-type, thereby potentially avoiding the need for each component to listen to all messages to determine the service-type, and avoiding the need to include the service-type in each message. Other means for addressing and routing messages in a multiple-component network are common in the art.

As noted above, each component preferably is aware of its physical parameters, including its relative location and orientation within the spacecraft. A variety of techniques are available to provide this information, including, for example, programming the information into each component when the spacecraft configuration is defined. However, in such a scenario, a redefined configuration will require a reprogramming of the affected components, which introduces the possibility of an oversight, such that the component's programmed location or orientation does not correspond to its actual location or orientation.

In a preferred embodiment, each component includes one or more devices that facilitate a determination of where the component is located. In most spacecraft, there are a limited number of spaces within which a component can be placed, and thus an “indexing” system can be used. For example, a component's location may be defined as “bay J”, and the component need only determine in which bay it is located, for example by detecting a signal specific to the bay. Typically, a spacecraft will include a “backbone” connection to the network at a location in the bay, from which the component's orientation is referenced. One of the spacecraft's special-purpose components 110-120 would typically be configured to provide the corresponding spacecraft-coordinates and/or surface-coordinates corresponding to each bay, as well as the location of the backbone connector in the bay, thereby allowing each component to determine its location and orientation directly. Because each component is configured to detect its corresponding bay, and its identified bay is used by each component to determine its actual location, changing the bay in which a component is placed will automatically effect a proper determination of its actual location.

In a “stacked”/“modular” spacecraft system, such as described in copending U.S. patent application ______, “MODULAR SPACECRAFT DESIGN ARCHITECTURE”, filed concurrently for Luis G. Jordan et al., Attorney Docket AA040517, incorporated by reference herein, a similar indexing system can be used, wherein the component's relative location on the stack provides an indication of its location relative to the spacecraft coordinate system. FIG. 5 illustrates an example technique for determining each component's relative location in a stacked spacecraft, or other spacecraft with an ordered arrangement of components.

In the example of FIG. 5, the network interconnection includes a line in which each component 100a-100n inserts a series resistor Ra-Rn. Components 110, 120 provide a constant current for this series-resistance path, so that a measure of the voltage Va-Vn at each component 100a-100n provides an indication of the component's position in the stack. If all of the resistors Ra-Rn are equal, these voltages will be indicative of the order in which the component is located on the stack. For example, if a 1 ma current is provided, and each resistor is 1000 ohms, there will be a one volt increment at each level of the stack. In a preferred embodiment, each component resistor Ra-Rn is sized to be proportional to the height of the component 100a-100n, so that a measure of the voltage provides a measure of the actual vertical position of each component. For example, each hundred ohms could represent one centimeter, so that with a 1 ma current source, if component 100a is 8 cm tall, Ra will be 800 ohms, and voltage Vb will be 0.8 volts, indicating that the base of component B is 8 cm above the lower component 110. Optionally, the lower component 110 may also include a resistor (not shown) that provides a measure of the height of the first component 100a relative to the vertical origin of the spacecraft.

In a preferred embodiment, one or more power supply components provide power to the components 100, and each component 100 is configured to monitor its current, and to terminate operations in the event of excessive current draw. FIG. 6 illustrates an example configuration of a component 100 with elements 610, 620 that provide this feature. A current sensor 620 is configured to open switch 610 whenever excessive current is detected. Additionally, the network 130 is also configured to control the switch 610, typically by also controlling, and overriding as required, the sensor 620 that controls the switch 610. Preferably, the switch 610 is configured to be ‘normally-open’, and requires an active control by the sensor 620 to close the switch. In such a configuration, the emergency control of the switch 610 can be provided by controlling the supply voltage provided to the sensor 620 to disable its activation of the switch 610.

In a preferred embodiment, the arbitration system includes software that is configured to handle emergency situations, such as unexpected loss-of-power, anomalous component behavior, and so on, even though the function of this software is not ‘arbitration’, in the conventional understanding of the term ‘arbitration’. In the example of FIG. 6, the switch 610 is configured to be controlled by the arbitration system via the network 130.

Note that each component 100 may include multiple power connections, each including some form of overcurrent protection. In this manner, select segments of each component, such as the network interface/communication segment, may remain operational after other segments are denied power. For example, in a preferred embodiment, the power-supply component(s) provide both regulated and unregulated power. The voltage-regulated power is intended to provide power to relatively low-power-consuming network-communication elements, and such elements as the sensor 620, discussed above, while an unregulated current source is provided to the remainder of the elements of the component. This provides the benefit of an isolation of the network-communication elements from potential anomalies caused by the other elements, and allows each component to manage its own power-regulation requirements.

In a preferred embodiment, the network 130 also includes lines that are dynamically assignable. Although such lines are typically physical wires that are interconnected, one of ordinary skill in the art will recognize that the principles presented herein can be applied to other forms of physical connections (e.g. fiber-optic), as well as wireless (e.g. RF and IR) communication channels. Hereinafter, the term “wire” is used to identify a channel on the network 130 over which a requested service may be provided.

In this example embodiment, some of the lines of the network 130 are not pre-assigned to a particular task, and are provided as a “service” to the components 100. These wires are requested and provided in a manner similar to other services, discussed above. In a typical embodiment, for example, a component may request power from a power-supply component, but the capacity of the lines in the network 130 that are assigned for providing power may not be sufficient to accommodate this additional power request. To satisfy the request for power, the power-supply component submits a request for wire(s), and if a spare wire is available for allocation, the controlling component responds to this request by assigning one or more wires for use by the power-supply component. In response to the request for power, the power-supply component refines the request by specifying that the requested power will be provided on the identified wire(s). In like manner, wires may be requested when two components need a communication bandwidth that is not available on the defined wires in the network, or when a particular ‘quality of service’ must be provided, and so on.

FIG. 7 illustrates an example embodiment of a component that is configured to be able to use allocatable wires 701 of the network 130. In this embodiment, the component 100 includes an M-by-N programmable switch 720, which is controlled by a processor 710. The processor 710 communicates with the other components via the defined wires 702, and requests and receives the response that indicates that a requested service will be provided via one or more wires of the allocatable wires 701. If the response is acceptable to the component 100, the component 100 accepts the response, and, at the scheduled time for this wire-allocation, the processor 710 controls the switch 720 to route the allocated wires to the appropriate conductors in the component 100. At the end of the scheduled time, the processor 710 controls the switch 720 to disconnect the allocated wires from the conductors in the component 100. This operation is performed by each of the components that are providing or receiving services via these allocated wires. One of ordinary skill in the art will recognize that the processor 710 and switch 720 may be configured to also provide the functions described above for the sensor 620 and switch 610 to control the switching of one or more defined wires 702, as well.

As noted above, in a preferred embodiment, the operation of the interaction among components are simulated and tested in a ground-based system before the spacecraft is deployed. Via such simulations and tests, conflicts identified by request-for-service transactions can serve to identify insufficient resources, problematic placements of components, and/or problematic placement of external devices of the components. If the conflict is identified during simulation, physical changes can be made to the spacecraft and/or to the components of the spacecraft to minimize such conflicts during the spacecraft's actual mission. because of the autonomous nature of the operation of the components in the spacecraft network, capabilities are preferably provided to simulate and test the combination of selected components in a variety of situations that are intended to emulate the actual mission profile.

Preferably, rather than selecting and arranging components and then determining whether the arrangement satisfy the mission requirements, the mission requirements are used as the driving factor for selecting and arranging the components. In a preferred embodiment, the tasks required to achieve a mission of the spacecraft are identified, and an automated or semi-automated process is used to selecting a set of components that are nominally configurable to perform the tasks. For example, the space-earth and/or space-space communication tasks will define a selection of one or more communication components; the imaging tasks will define the selection of an imaging component, as well as the selection of a particular attitude-controlling component; and so on.

From this core set of function components, an initial set of service requirements for these components can be defined. For example, the expected memory requirements can be estimated based on the set of identified components, and other specific requirements of each components can be defined and accumulated as appropriate. From these identified service requirements, a determination can be made as to whether the selected components can be expected to be able to satisfy the demand for these services. For example, a processing component may have been identified as being required for a particular mission task, and this processing component may have sufficient memory capacity to satisfy the aforementioned expected memory requirements of the other selected components.

If any service requirement is identified that cannot be satisfied by the selected components, one or more additional components are selected to provide these lacking services, and the above process is repeated until a sufficient complement of components are provided to satisfy each of their demands for service. Preferably, the above referenced simulations and emulations are performed during this iterative process of determining the need for additional service capabilities. These simulations and emulations will also provide a measure of the degree of conflict that can be expected during the mission to satisfy the demands for service, and tradeoffs can be made between an acceptable level of service-satisfaction versus the need for additional service capabilities.

With a final set of components assembled, it is likely that several components will overlap in functionality. There will be several devices capable of determining spacecraft orientation to various levels of precision, possibly several devices capable of communicating with ground or space resources, and very likely several devices capable of providing power resources such as solar panels and batteries. Because each of these devices is not specifically commanded or controlled to perform some primary task, but rather the devices respond to any and all resource requests that they can fulfill to some level, the valuable attribute of “graceful degradation” is built into the architecture automatically without any need for explicit design to accomplish this. For example, a solar panel array can determine, very coarsely, the direction of the Sun. In normal operations, the direction of the Sun would be determined by a dedicated attitude determination component, to good precision and with fast response time. When a request for the service of “direction to Sun” was broadcast, both the solar panel component and the attitude determination component would respond, and the dedicated attitude control component would always be chosen, since it could provide the best answer. If however this dedicated component malfunctioned and was no longer providing this service, the solar panel component would still be providing its offer, and it would be accepted as the best offer available, resulting in degraded but still correct spacecraft behavior. Thus the best available graceful degradation path is presented for all resources at all times, not because all possible failure modes were predetermined, but because the request/response architecture causes it to occur naturally.

The foregoing merely illustrates the principles of the invention. It will thus be appreciated that those skilled in the art will be able to devise various arrangements which, although not explicitly described or shown herein, embody the principles of the invention and are thus within its spirit and scope. For example, while the network described herein contains many elements specifically useful to the use of such a network on a single physically integrated spacecraft, one of ordinary skill in the art will recognize that the act of requesting and providing resources can happen among various physically separate spacecraft, on various physically distinct networks on the same spacecraft, between the spacecraft and the ground, among a variety of ground nodes and a variety of spacecraft nodes, and any similar combination. Also, although the network and architecture defined herein is presented using the example of virtually total autonomy among the components 100, one of ordinary skill in the art will recognize that a ‘hybrid’ embodiment, including a centralized controller that handles select tasks, and semi-autonomous components that handle other tasks, may also be used. Conversely, the tasks that are identified herein as preferably being handled by special-purpose components 110, 120, may be included in the generic components 100a-n, thereby providing even greater autonomy and flexibility. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts is intended to be required unless specifically indicated; and
i) the term “plurality of” an element includes two or more of the claimed element, and does not imply any particular range of number of elements; that is, a plurality of elements can be as few as two elements.

I claim:

1. A spacecraft network comprising
a plurality of function components,
wherein
each component of the plurality of function components is configured to communicate a request for service to the network, and
each other component of the plurality of function components is configured to provide a response to the request, if the other component is able to provide some or all of the service.

2. The spacecraft network of claim 1, wherein
the request for service includes a time parameter that indicates when the service is desired.

3. The spacecraft network of claim 1, wherein
the time parameter includes an occurrence of an event.

4. The spacecraft network of claim 1, wherein
each component is also configured to communicate characteristics of the component to the network, and
at least one of the other components is configured to adjust its operation based on at least one of the characteristics of the component.

5. The spacecraft network of claim 4, wherein
the characteristics include:
physical properties,
orientation within the spacecraft, and
location within the spacecraft.

6. The spacecraft network of claim 5, wherein
the location within the spacecraft is identified relative to at least one of:
a spacecraft-based coordinate system, and
a spacecraft-surface coordinate system.

7. The spacecraft network of claim 1, wherein
the request for service includes at least one of:
request for power,
request for orientation information,
request for location information,
request for reorientation,
request for communications,
request for memory, and
request for imagery.

8. The spacecraft network of claim 1, further including
an arbitration unit that is configured to arbitrate among potentially conflicting responses to requests.

9. The spacecraft network of claim 8, wherein
two or more of the plurality of function components are configured to be able to contain the arbitration unit.

10. The spacecraft network of claim 8, wherein
the arbitration unit is further configured to control an amount of power provided to each component.

11. The spacecraft network of claim 1, wherein
the network is configured to provide power to each component,
the power including at least one of:
a voltage-regulated power source, and
a voltage-bounded current source.

12. The spacecraft network of claim 11, wherein
in at least one of the components, the voltage-regulated power source at the component controls access of the component to the current source.

13. The spacecraft network of claim 1, wherein
the network includes a signal line that facilitates a determination of each component's relative location in the spacecraft.

14. The spacecraft network of claim 13, wherein
each component is configured to place an impedance in series with the signal line, so that a measure of a voltage on the signal line at each component is indicative of the component's relative location in the spacecraft.

15. The spacecraft system of claim 1, wherein the plurality of components include:
a power-supply component,
a processing component,
a communications component, and
an attitude-control component.

16. A method of operating a spacecraft, comprising:
generating requests for services from a plurality of components of the spacecraft to a network,
generating responses to the requests for services from each of the components that are able to provide some or all of the services,
selecting components that are able to provide the services, and
providing the services from the selected components that are able to provide the services to the components that requested the services.

17. The method of claim 16, further including:
arbitrating among conflicting requests for services.

18. The method of claim 16, wherein
the services include:
power, communication, storage, and positioning.

19. The method of claim 16, wherein
the requests for services include a time parameter that indicates when each service is desired.

20. The method of claim 19, wherein
the time parameter includes an occurrence of an event.

21. A method of configuring a spacecraft, comprising:
identifying tasks required to achieve a mission of the spacecraft,
selecting a first set of function components that are configured to perform the tasks,
determining service requirements of each of the first set of function components,
determining which service requirements cannot be provided by the first set of function components, and
selecting a second set of function components that are configured to provide the service requirements that cannot be provided by the first set of function components, if any;
wherein
each component of the first and second set of function components is configured to communicate requests for services to the other components of the first and second set, and to respond to requests for services from the other components if the component can provide the service.

22. The method of claim 21, further including
simulating performance of the tasks, to verify that the first and second set of function components are suitable for performing the tasks.
